(19) United States
(12) Patent Application Publication
(10) Pub. No.: US 2018/0164493 A1
(43) Pub. Date: Jun. 14, 2018

(54) CLUSTER-SHAPED LIGHT-EXTRACTING ELEMENT

(71) Applicant: Rambus Delaware LLC, Sunnyvale, CA (US)

(72) Inventors: Kurt Starkey, Strongsville, OH (US); Robert Ezell, Brunswick, OH (US)

(21) Appl. No.: 15/837,425

(22) Filed: Dec. 11, 2017

Related U.S. Application Data
(60) Provisional application No. 62/463,160, filed on Feb. 24, 2017.
(60) Provisional application No. 62/432,062, filed on Dec. 9, 2016.

(51) Int. Cl. F21V 8/00

(52) U.S. Cl. CPC G02B 6/0036; G02B 6/009

(57) ABSTRACT

A light guide includes a first major surface, second major surface, and light input edge extending between the major surfaces, the major surfaces configured to propagate light input to the light guide therebetween by total internal reflection. Light extracting elements are at at least one of the major surfaces, at least one of the light extracting elements embodied as a cluster-shaped light extracting element and including an intersection portion and at least three members extending therefrom. Each member includes a first side surface and second side surface that come together to form a ridge or that are joined by a connecting surface, the ridge or connecting surface including a first end that intersects the major surface at which the micro-optical element is formed and extending to the intersection portion where the ridge or connecting surface intersects with one or more ridges or connecting surfaces of the other respective members.

### RELATED APPLICATION DATA

This application claims the benefit of U.S. Provisional Patent Application No. 62/432,062, filed Dec. 9, 2016; and claims the benefit of U.S. Provisional Patent Application No. 62/463,160, filed Feb. 24, 2017; the disclosures of which are incorporated herein by reference in their entireties.

### BACKGROUND

Energy efficiency has become an area of interest for energy consuming devices. One class of energy consuming devices is lighting devices. Light emitting diodes (LEDs) show promise as energy efficient light sources for lighting devices. For some LED-based lighting assemblies, the light emitted from the light source is input to a light guide and light extracting elements specularly extract the light from the light guide in a defined direction. But control over light output distribution can be an issue for lighting devices that use LEDs or similar light sources. Visual artifacts may also appear at the major surface(s) of the illuminated lighting assembly and can present an issue.

### SUMMARY

In accordance with one aspect of the present disclosure, a light guide includes: a first major surface; a second major surface opposed the first major surface; a light input edge extending between the first major surface and the second major surface, the first major surface and the second major surface configured to propagate light input to the light guide through the light input edge therebetween by total internal reflection; and light extracting elements at at least one of the major surfaces, at least one of the light extracting elements embodied as a cluster-shaped light extracting element including: an intersection portion; and at least three members extending from the intersection portion, each member including a first side surface and a second side surface that come together to form a ridge or that are joined by a connecting surface, the ridge or connecting surface including a first end that intersects the major surface at which the light extracting element is formed and extending to the intersection portion where the ridge or connecting surface intersects with one or more ridges or connecting surfaces of the other respective members.

In some embodiments, the members extend radially from the intersection portion.

In some embodiments, each member extends linearly from the intersection portion.

In some embodiments, at least one of the members extends non-linearly from the intersection portion. In some embodiments, the at least one of the members curves about an axis extending perpendicular to the major surface at which the light extracting element is formed. In some embodiments, the at least one of the members extends from the intersecting portion in a sinusoidal pattern.

In some embodiments, the at least one of the light extracting elements includes at least six members extending from the intersecting portion.

In some embodiments, the light extracting elements including multiple instances of the cluster-shaped light extracting element. In some embodiments, at least a portion of the cluster-shaped light extracting elements have different respective shapes. In some embodiments, at least a portion of the cluster-shaped light extracting elements have different respective rotational orientations.

In accordance with another aspect of the present disclosure, a lighting assembly includes: a first major surface; a second major surface opposed the first major surface; a light input edge extending between the first major surface and the second major surface, the first major surface and the second major surface configured to propagate light input to the light guide through the light input edge therebetween by total internal reflection; and light extracting elements at at least one of the major surfaces, at least one of the light extracting elements embodied as a cluster-shaped light extracting element including: an intersection portion; and at least three members extending from the intersection portion, each member including a first side surface and a second side surface that come together to form a ridge or that are joined by a connecting surface, the ridge or connecting surface including a first end that intersects the major surface at which the light extracting element is formed and extending to the intersection portion where the ridge or connecting surface intersects with one or more ridges or connecting surfaces of the other respective members; and a light source adjacent the light input edge.

In accordance with another aspect of the present disclosure, an optical element formed at a major surface of a substrate includes: an intersection portion; and at least three members extending from the intersection portion, each member including a first side surface and a second side surface that come together to form a ridge or that are joined by a connecting surface, the ridge or connecting surface including a first end that intersects the major surface at which the optical element is formed and extending to the intersection portion where the ridge or connecting surface intersects with one or more ridges or connecting surfaces of the other respective members.

In some embodiments, the members extend radially from the intersection portion.

In some embodiments, each member extends linearly from the intersection portion.

In some embodiments, at least one of the members extends non-linearly from the intersection portion. In some embodiments, the at least one of the members curves about an axis extending perpendicular to the major surface at which the optical element is formed. In some embodiments, the at least one of the members extends from the intersecting portion in a sinusoidal pattern.

In some embodiments, at least one of the portion of the optical elements includes at least six members extending from the intersecting portion.

In some embodiments, the substrate is a cover element, including: a first major surface; and a second major surface opposed the first major surface.

In some embodiments, the substrate is an optical film.

In accordance with another aspect of the present disclosure, a light guide includes: a first major surface; a second major surface opposed the first major surface; a light input edge extending between the first major surface and the second major surface, the first major surface and the second major surface configured to propagate light input to the light guide through the light input edge therebetween by total internal reflection; and cluster-shaped light extracting means at at least one of the major surfaces for exatracting light from the light guide through one or both of the first major surface and the second major surface.

### BRIEF DESCRIPTION OF THE DRAWINGS

FIG. 1 is a schematic perspective view of an exemplary lighting assembly.

FIGS. 2 and 3 are schematic side views of parts of exemplary lighting assemblies.

FIG. 4 is a schematic top view of an exemplary cluster-shaped light extracting element.

FIGS. 5 and 6 are schematic cross-sectional views of portions of an exemplary cluster-shaped light extracting element.

FIG. 7 is a schematic top view of an exemplary cluster-shaped light extracting element.

FIG. 8 is a schematic cross-sectional view of a portion of an exemplary cluster-shaped light extracting element.

FIG. 9 is a schematic top view of an exemplary cluster-shaped light extracting element.

FIG. 10 is a schematic cross-sectional view of a portion of an exemplary cluster-shaped light extracting element.

FIG. 11 is a schematic top view of an exemplary cluster-shaped light extracting element.

FIG. 12 is a schematic cross-sectional view of a portion of an exemplary cluster-shaped light extracting element.

FIGS. 13-15 are schematic top views of exemplary cluster-shaped light extracting elements.

FIGS. 16 and 17 are scanning electron microscope (SEM) images of exemplary cluster-shaped light extracting elements.

FIGS. 18-28 are schematic top views of exemplary cluster-shaped light extracting elements.

FIGS. 29-32 are schematic cross-sectional views of portions of exemplary cluster-shaped light extracting elements.

FIGS. 33 and 34 are schematic views of exemplary grid arrangements in which light extracting elements may be provided.

FIGS. 35 and 36 are scanning electron microscope (SEM) images of exemplary cluster-shaped light extracting elements.

FIG. 37 is a schematic top view of an exemplary lighting assembly.

FIG. 38 is a schematic side view of an exemplary lighting assembly.

FIG. 39 is a schematic top view of an exemplary cover element.

### DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments. In this disclosure, angles of incidence, reflection, and refraction and output angles are measured relative to the normal to the surface (e.g., the major surface).

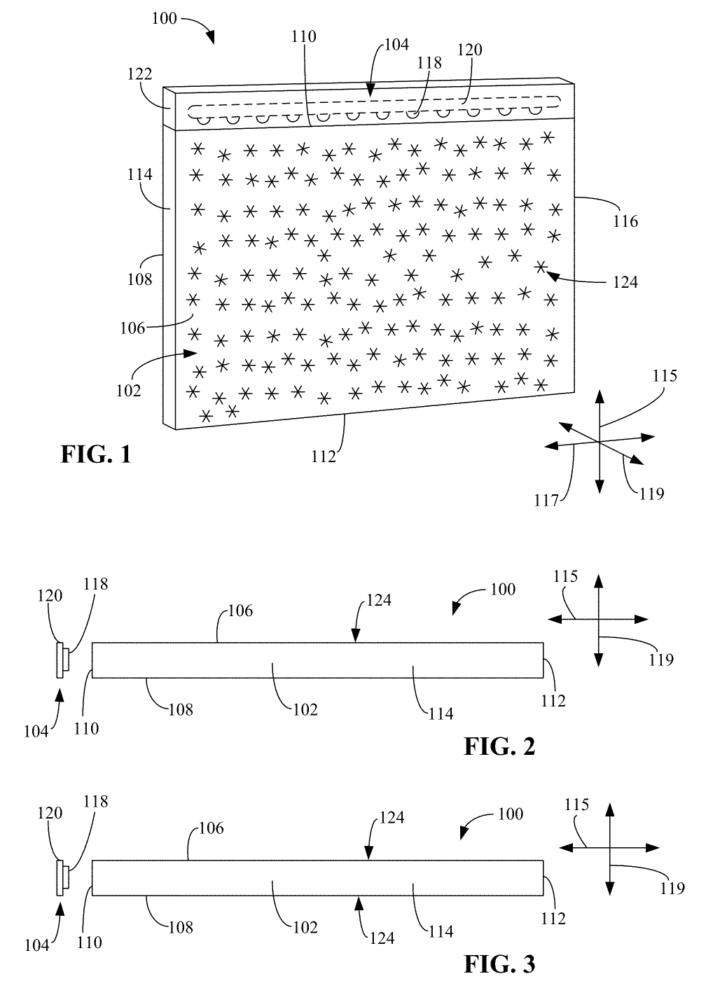

With initial reference to FIG. 1, an exemplary embodiment of a lighting assembly is shown at 100. The lighting assembly 100 includes a light guide 102. The light guide 102 is a solid article of manufacture (e.g., a substrate) made from, for example, polycarbonate, poly(methyl-methacrylate) (PMMA), glass, or other appropriate material. The light guide 102 may also be a multi-layer light guide having two or more layers. The two or layers may differ in refractive index. The light guide 102 includes a first major surface 106 and a second major surface 108 opposite the first major surface 106. The light guide 102 is configured to propagate light by total internal reflection between the first major surface 106 and the second major surface 108. The length and width dimensions of each of the major surfaces 106, 108 are greater, typically ten or more times greater, than the thickness of the light guide 102. The thickness is the dimension of the light guide 102 in a direction orthogonal to the major surfaces 106, 108 (i.e., thickness direction 119). The thickness of the light guide 102 may be, for example, about 0.1 millimeters (mm) to about 10 mm.

At least one edge surface extends between the major surfaces 106, 108 of the light guide in the thickness direction. The total number of edge surfaces depends on the configuration of the light guide. In the case where the light guide is rectangular, the light guide has four edge surfaces 110, 112, 114, 116. In the embodiment shown, the light guide extends in a first direction 115 (e.g., a length direction) between edge surface 110 and edge surface 112; and extends in a second direction 117 (e.g., a width direction) orthogonal to the first direction 115 between edge surface 114 and edge surface 116. Other light guide shapes result in a corresponding number of side edges. Although not shown, in some embodiments, the light guide 102 may additionally include one or more edge surfaces defined by the perimeter of an orifice extending through the light guide in the thickness direction. Each edge surface defined by the perimeter of an orifice extending through the light guide 102 will hereinafter be referred to as an internal edge surface. Depending on the shape of the light guide 102, each edge surface may be straight or curved, and adjacent edge surfaces may meet at a vertex or join in a curve. Moreover, each edge surface may include one or more straight portions connected to one or more curved portions. The edge surface through which light from the light source 104 is input to the light guide will now be referred to as a light input edge. In the embodiment shown in FIG. 1, the edge surface 110 is a light input edge. In some embodiments, the light guide 102 includes more than one light input edge. For example, a light source may also be present at the edge surface 112 opposite the edge surface 110. Furthermore, the one or more light input edges may be straight and/or curved.

In the embodiment shown in FIG. 1, the major surfaces 106, 108 are planar. In other embodiments, at least a portion of the major surfaces 106, 108 of the light guide 102 is curved in one or more directions. In one example, the intersection of the light input edge 110 and one of the major surfaces 106, 108 defines a first axis, and at least a portion of the light guide 102 curves about an axis parallel to the first axis. In another example, at least a portion of the light guide 102 curves about an axis orthogonal to the first axis. Other exemplary shapes of the light guide include a semi-cylindrical body, a dome, a hollow cylinder, a hollow cone or pyramid, a hollow frustrated cone or pyramid, a bell shape, an hourglass shape, or another suitable shape.

In an example, the light guide may include major surfaces 106, 108 that are rectangular (e.g., square or otherwise) in shape. In one exemplary embodiment, the light guide is formed as a 2′×2′ square. In other exemplary embodiments, the light guide is formed as a rectangle having a different size (e.g., 1′×4′, 2′×4′, 4′×4′, etc.). In another example (not shown), the light guide may include major surfaces 106,108 that have another suitable polygonal shape. Exemplary shapes include a triangle, other quadrilateral shape such as a parallelogram, rhombus, or trapezoid, pentagon, hexagon, heptagon, octagon, or other suitable shape. In another example, the light guide may include major surfaces 106, 108 that are circular or ovular in shape. Such examples of the light guide can be used as part of a lighting assembly for one of several general lighting implementations, such as ceiling fixtures, wall fixtures, and the like.

With continued reference to FIG. 1, the lighting assembly 100 includes a light source 104 positioned adjacent the light input edge 110. The light source 104 is configured to edge light the light guide 102 such that light from the light source 104 enters the light input edge 110 and propagates along the light guide 102 by total internal reflection at the major surfaces 106, 108. In embodiments where the light guide includes more than one light input edge, the lighting assembly 100 may include a corresponding number of light sources 104.

The light source 104 may include one or more solid-state light emitters 118. The solid-state light emitters 118 constituting the light source 104 are arranged linearly or in another suitable pattern depending on the shape of the light input edge of the light guide 102 to which the light source 104 supplies light. Exemplary solid-state light emitters 118 include such devices as LEDs, laser diodes, and organic LEDs (OLEDs). In an embodiment where the solid-state light emitters 118 are LEDs, the LEDs may be top-fire LEDs or side-fire LEDs, and may be broad spectrum LEDs (e.g., white light emitters) or LEDs that emit light of a desired color or spectrum (e.g., red light, green light, blue light, or ultraviolet light), or a mixture of broad-spectrum LEDs and LEDs that emit narrow-band light of a desired color. In one embodiment, the solid-state light emitters 118 emit light with no operably-effective intensity at wavelengths greater than 500 nanometers (nm) (i.e., the solid-state light emitters 118 emit light at wavelengths that are predominantly less than 500 nm). In some embodiments, the solid-state light emitters 118 constituting light source 104 all generate light having the same nominal spectrum. In other embodiments, at least some of the solid-state light emitters 118 constituting light source 104 generate light that differs in spectrum from the light generated by the remaining solid-state light emitters 118. For example, two different types of solid-state light emitters 118 may be alternately located along the light source 104.

The lighting assembly 100 may include one or more additional components. For example, although not specifically shown in detail, in some embodiments of the lighting assembly, the light source 104 includes structural components to retain the solid-state light emitters 118. In the example shown in FIG. 1, the solid-state light emitters 118 may be mounted to a printed circuit board (PCB) 120. The light source 104 may additionally include circuitry, power supply, electronics for controlling and driving the solid-state light emitters 118, and/or any other appropriate components. The lighting assembly 100 may include a housing 122 for retaining the light source 104 and the light guide 102. The housing 122 may retain a heat sink or may itself function as a heat sink. In some embodiments, the lighting assembly 100 includes a mounting mechanism (not shown) to mount the lighting assembly to a retaining structure (e.g., a ceiling, a wall, etc.). The lighting assembly 100 may include a reflector (not shown) adjacent one of the major surfaces 106, 108. The reflector may be a specular reflector, a diffuse reflector, or a patterned reflector. The light extracted through the major surface adjacent the reflector may be reflected by the reflector, re-enter the light guide 102 at the major surface, and be output from the light guide 102 through the other major surface.

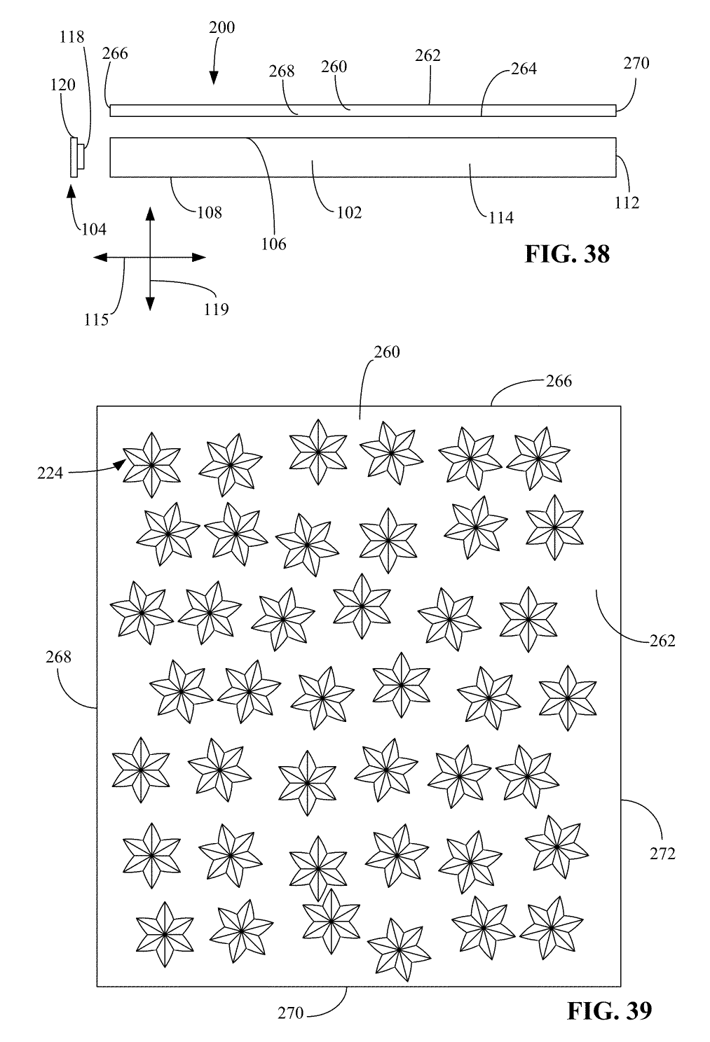

In some embodiments, the lighting assembly 100 may include a cover element adjacent one of the major surfaces 106, 108. An exemplary cover element is described below with respect to FIGS. 38 and 39 in the context of lighting assembly 200. The light extracted through the major surface of the light guide adjacent the cover element may pass through the cover element and may be redirected. The cover element may be a solid article of manufacture (e.g., a substrate) made from, for example, polycarbonate, poly(methyl-methacrylate) (PMMA), glass, or other appropriate material; and may include a first major surface and a second major surface opposite the first major surface. A major surface of the cover element may be located adjacent one of the major surfaces 106, 108 of the light guide 102. The cover element may include light redirecting elements (e.g., similar to the light extracting elements described below) at at least one of its major surfaces configured to redirect light passed therethrough.

With continued reference to FIG. 1, the light guide 102 includes optical elements embodied as light extracting elements 124 in, on, or beneath at least one of the major surfaces 106, 108. Light extracting elements that are in, on, or beneath a major surface will be referred to as being “at” the major surface. In FIG. 1, the light extracting elements 124 are generically shown as asterisk-shaped elements. While the light extracting elements 124 are generically shown in FIG. 1 as asterisk-shaped elements, it will be understood that the light extracting elements can respectively have one or more specific configurations, such as those described below. FIG. 2 is a schematic side view of one exemplary implementation of the lighting assembly 100. In this exemplary embodiment shown in FIG. 2, light extracting elements 124 are at the first major surface 106, but they are not present at the second major surface 108. FIG. 3 is a schematic side view of another exemplary implementation of the lighting assembly 100. In this exemplary embodiment shown in FIG. 3, light extracting elements 124 are at the first major surface 106, and light extracting elements are also present at the second major surface 108.

Each light extracting element 124 functions to disrupt the total internal reflection of the light propagating in the light guide and incident thereon. In one embodiment, the light extracting elements 124 reflect light toward the opposing major surface so that the light exits the light guide 102 through the opposing major surface. Alternatively, the light extracting elements 124 transmit light through the light extracting elements 124 and out of the major surface of the light guide 102 having the light extracting elements 124. In another embodiment, both types of light extracting elements 124 are present. In yet another embodiment, the light extracting elements 124 reflect some of the light and refract the remainder of the light incident thereon, and therefore the light extracting elements 124 are configured to extract light from the light guide 102 through one or both of the major surfaces 106, 108.

Exemplary light extracting elements 124 include features of well-defined shape, such as grooves (e.g., V-grooves and/or truncated V-grooves) that are recessed into or protrude from the major surface. Other exemplary light extracting elements 124 include micro-optical elements, which are features of well-defined shape that are small relative to the linear dimensions of the major surfaces 106, 108. The smaller of the length and width of a micro-optical element is less than one-tenth of the longer of the length and width (or circumference) of the light guide 102 and the larger of the length and width of the micro-optical element is less than one-half of the smaller of the length and width (or circumference) of the light guide 102. The length and width of the micro-optical element is measured in a plane parallel to the major surface 106, 108 of the light guide 102 for planar light guides or along a surface contour for non-planar light guides 102. The reference numeral 124 will be generally used to collectively refer to the different embodiments of light extracting elements. Exemplary micro-optical elements are described in U.S. Pat. No. 6,752,505 and, for the sake of brevity, are not described in detail in this disclosure. The micro-optical elements may vary in one or more of size, shape, depth or height, density, orientation, slope angle or index of refraction such that a desired light output from the light guide is achieved.

Light extracting elements 124 of well-defined shape are shaped to predictably reflect and/or refract the light propagating in the light guide 102. In some embodiments, at least one of the light extracting elements 124 is an indentation (depression) of well-defined shape in the major surface 106, 108. In other embodiments, at least one of the light extracting elements 124 is a protrusion of well-defined shape from the major surface 106, 108. The light extracting elements of well-defined shape have distinct surfaces on a scale larger than the surface roughness of the major surfaces 106, 108. Light extracting elements of well-defined shape exclude features of indistinct shape or surface textures, such as printed features of indistinct shape, ink-jet printed features of indistinct shape, selectively-deposited features of indistinct shape, and features of indistinct shape wholly formed by chemical etching or laser etching.

The light extracting elements 124 are configured to extract light in a defined intensity profile (e.g., a uniform intensity profile) and with a defined light ray angle distribution from one or both of the major surfaces 106, 108. In this disclosure, intensity profile refers to the variation of intensity with regard to position within a light-emitting region (such as the major surface or a light output region of the major surface). The term light ray angle distribution is used to describe the variation of the intensity of light with ray angle (typically a solid angle) over a defined range of light ray angles. In an example in which the light is emitted from an edge-lit light guide, the light ray angles can range from −90° to +90° relative to the normal to the major surface. Each light extracting element 124 of well-defined shape includes at least one surface configured to refract and/or reflect light propagating in the light guide 102 and incident thereon such that the light is extracted from the light guide. Such surface(s) is also herein referred to as a light-redirecting surface.

In order to achieve a defined intensity profile, light ray angle distribution, and visual appearance of the light guide, light extracting elements 124 of well-defined shape (such as micro-optical elements) are conventionally configured and arranged in a particular manner, taking into consideration factors of the lighting assembly such as the size, shape, light input direction(s), and number of light input edges of the light guide. However, configuring and arranging the micro-optical elements to achieve a desired parameter may reduce another one of the parameters to an unacceptable level, and there may be a struggle between the appearance of a light guide versus the optical performance. Furthermore, the configuration is typically specific for a particular light guide size, shape, and light input arrangement, and typically needs to be reconfigured in order to achieve similar parameters for a different light guide size, shape and/or light input arrangement.

As an example, an edge lit light guide may include an array of light extracting elements at one or more of its major surfaces to extract light in a desired manner. These light extracting elements are typically arranged in a particular manner in order to reduce unwanted visual effects such as “headlighting” (i.e., the appearance of relatively high-intensity areas of light shown as one or more columns of light extending along the light guide from the light input edge) and/or “banding” (i.e., the appearance of relatively high-intensity areas of light shown as one or more bands of light extending relatively parallel to the light input edge). But the geometry of these micro-optical elements may not allow for realization of the same desired output distribution when the light guide is edge lit from a different direction and/or when the given arrangement of light extracting elements is provided in a different size/shape light guide. Hence, the configuration and arrangement of these micro-optical elements conventionally must be redesigned for each respective light guide arrangement.

Some light extracting elements such as cones, truncated cones, and hemispheres may help to improve the ability of the light guide to produce similar light output distributions when lit from different directions, but such light extracting elements tend to increase the prevalence of the unwanted visual effect(s) (e.g., headlighting and/or banding). And while the addition of diffusers or other secondary films/sheets (e.g., located adjacent one or both of the major surfaces 106, 108) may be utilized to reduce unwanted visual effects, its inclusion may result in additional cost, efficiency reduction, and/or an undesired output distribution profile. Furthermore, in many applications (e.g., as a lighting fixture, a sign, a display apparatus, etc.), the use of diffusers or other secondary films/sheets is not preferable (e.g., for aesthetic reasons).

In accordance with the present disclosure, one or more light extracting elements provided at the major surface(s) of the light guide may be embodied as a cluster-shaped light extracting element. The light extracting elements of the present disclosure are referred to herein as “cluster-shaped” because of the manner in which the members of the light extracting element are arranged and meet at the intersection portion of the element. In some embodiments, the cluster-shaped light extracting element may provide a nominally symmetric light output distribution even when light is input to the light guide in different directions (e.g., from different edge surfaces). The term “nominally” encompasses variations of one or more parameters that fall within acceptable tolerances in design and/or manufacture. Hence, the cluster-shaped light extracting elements may allow for a defined intensity profile and/or light ray angle distribution to be maintained, even when the light guide is edge lit from a different input edge, or when the light guide is provided in a different shape and/or size. However, the design of the cluster-shaped light extracting element may provide flexibility for providing embodiments in which different desired intensity profiles and/or light ray angle distributions may be achieved, depending on the direction in which the light guide is lit.

Multiple cluster-shaped light extracting elements may be included (e.g., in an array, grid, or other suitable arrangement) at the major surface(s) of the light guide. A portion or all of the light extracting elements at the major surface(s) may be cluster-shaped light extracting elements. The cluster-shaped light extracting elements may also reduce undesired visual effects (e.g., headlighting and/or banding) at the major surface of the light guide.

The cluster-shaped light extracting element may be configured as a depression or protrusion at the major surface of the light guide. In most of the exemplary embodiments shown in the figures, the cluster-shaped light extracting element as a depression at the major surface. However, it will be appreciated that any of the embodiments of the cluster-shaped light extracting element shown and described herein may alternatively be provided as a protrusion at the major surface.

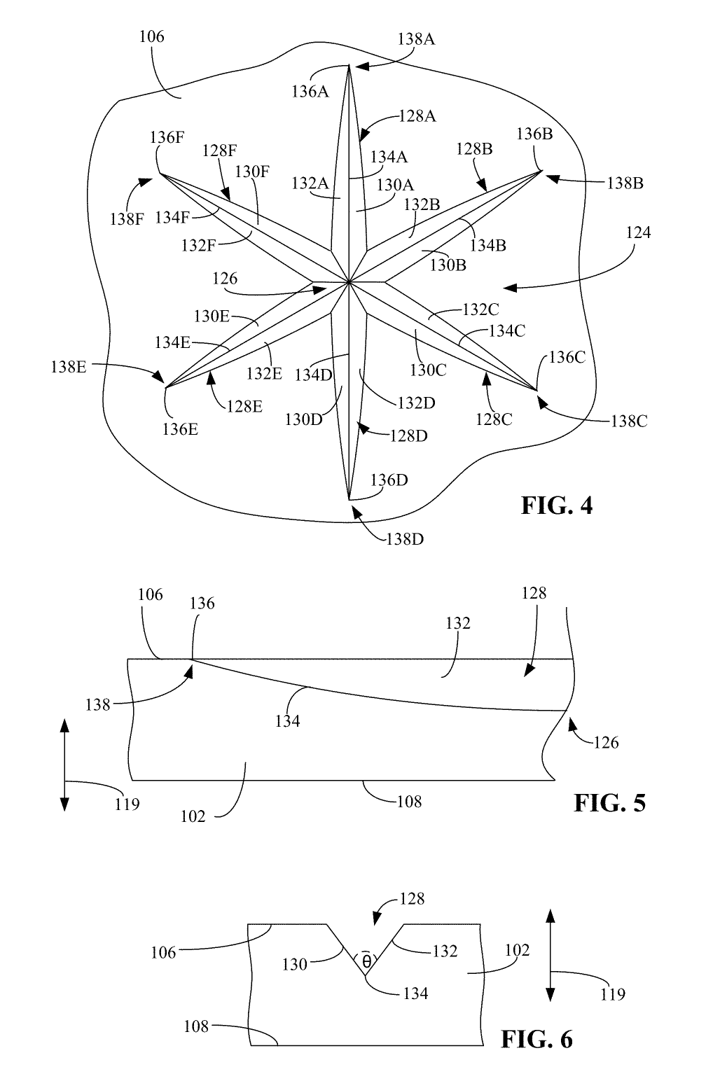

FIGS. 4-6 show one exemplary embodiment of a cluster-shaped light extracting element. In this exemplary embodiment, the element is embodied as a micro-optical element. FIG. 4 shows a top view of the cluster-shaped light extracting element as viewed from a direction orthogonal to the major surface 106. FIG. 5 shows a cross-sectional view of one of the members of the cluster-shaped light extracting element as viewed from a direction orthogonal to the thickness direction 119 and orthogonal to the direction in which the ridge of the member extends. FIG. 6 shows a cross-sectional view of one of the members of the cluster-shaped light extracting element as viewed from a direction orthogonal to the thickness direction 119 and parallel to the direction in which the ridge of the member extends.

As shown in FIG. 4, the cluster-shaped light extracting element 124 includes an intersection portion 126 and members that extend from the intersection portion 126 in a plane parallel to the major surface at which the element is formed. In the embodiment shown, the cluster-shaped light extracting element includes six members 128A, 128B, 128C, 128D, 128E, 128F. Reference numeral 128 will be used to refer generally to the respective members of the cluster-shaped light extracting element. Each member may also be referred to as an “arm” or a “leg”. In the example shown, the intersection portion 126 is at the center (e.g., nucleus) of the element and the members 128 extend radially from the intersection portion 126. Each member extends from the intersection portion 126 to a respective distal end 138A, 138B, 138C, 138D, 138E, 138F. Reference numeral 138 will be used to refer generally to the respective distal ends of the members of the cluster-shaped light extracting element.

Each member includes a respective first side surface 130A, 130B, 130C, 130D, 130E, 130F and a respective second side surface 132A, 132B, 132C, 132D, 132E, 132F that come together to form a respective ridge 134A, 134B, 134C, 134D, 134E, 134F. Reference numeral 130 will be used to refer generally to the respective first side surfaces of the cluster-shaped light extracting element; reference numeral 132 will be used to refer generally to the respective second side surfaces of the cluster-shaped light extracting element; and reference numeral 134 will be used to refer generally to the respective ridges of the cluster-shaped light extracting element. The ridge of a given member has a respective first end 136A, 136B, 136C, 136D, 136E, 136F that intersects the major surface at which the cluster-shaped light extracting element is formed (e.g., at the distal end of the member), and the ridge extends to the intersection portion 126. The part of the ridge that intersects with one or more respective ridges of the other members at the intersection portion 126 may also be referred to as the second end of the ridge. Reference numeral 136 will be used to refer generally to the respective first ends of the ridges of the cluster-shaped light extracting element.

FIGS. 5 and 6 show an exemplary configuration of each of the members 128 of the cluster-shaped light extracting element 124 shown in FIG. 4. With reference to FIG. 5, the ridge 134 of a given one of the members 128 is arcuate in shape as viewed from a direction orthogonal to the thickness direction 119 and orthogonal to the direction in which the ridge 134 of the member extends (e.g., arcuate in a plane perpendicular to the major surface and parallel to the direction in which ridge 134 of the member extends). With reference to FIG. 6, the first surface 130 and the second surface 132 of the member 128 are angled relative to one another such that they form a v shape. The included angle θ formed between the first side surface 130 and the second side surface 132 of a given member may be any suitable angle, and may be set for extracting light from the light guide at a defined intensity profile and/or light ray angle distribution. As an example, the included angle θ formed between the first side surface 130 and the second side surface 132 of a given member 128 may range from about 30° to about 165°. In the example shown, the included angle θ formed between the first side surface 130 and the second side surface 132 is about 70°. In other embodiments (such as those embodiments described below in FIGS. 12-18), the included angle θ formed between the first side surface 130 and the second side surface 132 is a different angle. In an example, each of the members of the cluster-shaped light extracting element may have nominally the same included angle θ. The included angle θ may be, for example, a factor in the width and/or depth of the members of the cluster-shaped light extracting element. In some embodiments, the first side surface 130 and the second side surface 132 are symmetric relative to a plane extending parallel to the direction in which ridge 134 of the member extends and extending normal to the major surface (e.g., in the thickness direction 119). In other embodiments, the first side surface 130 and the second side surface 132 are asymmetric relative to a plane extending parallel to the direction in which ridge 134 of the member extends and extending normal to the major surface (e.g., in the thickness direction 119).

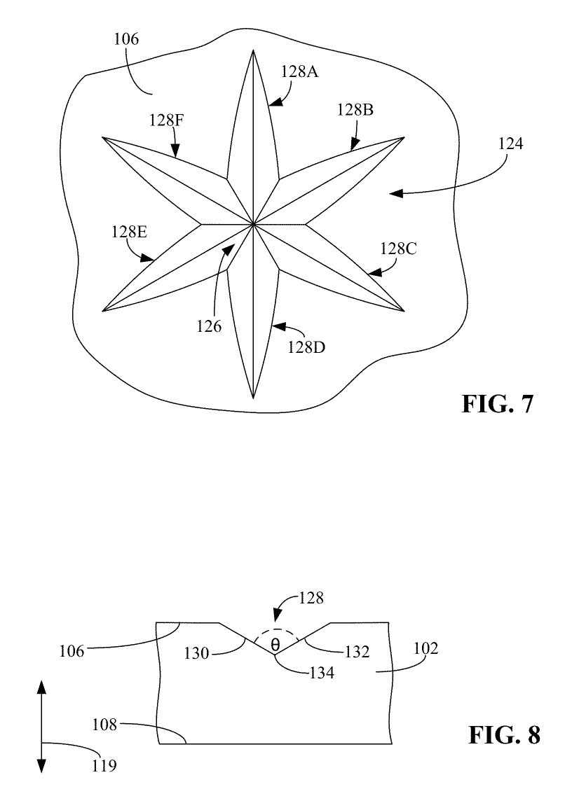

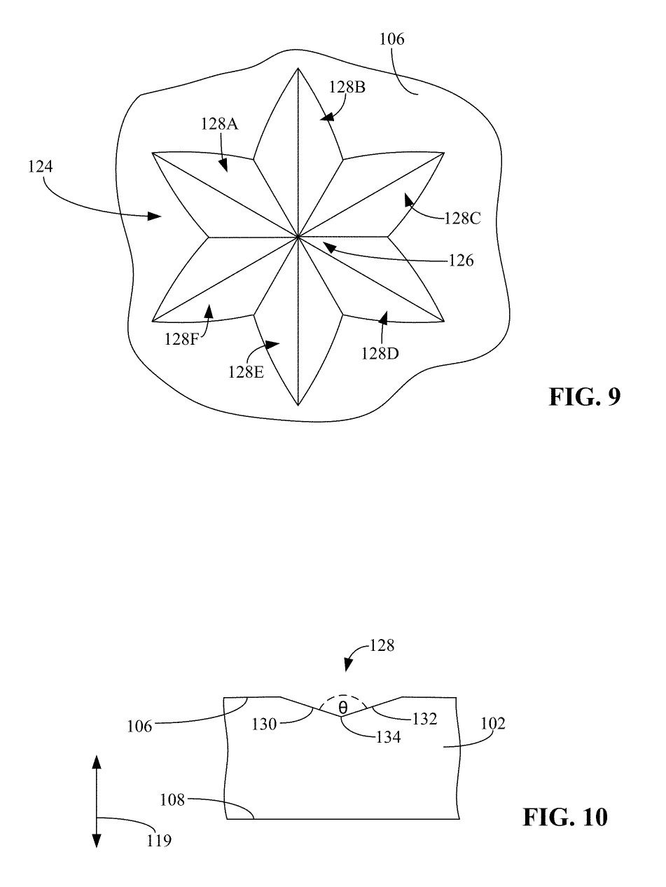

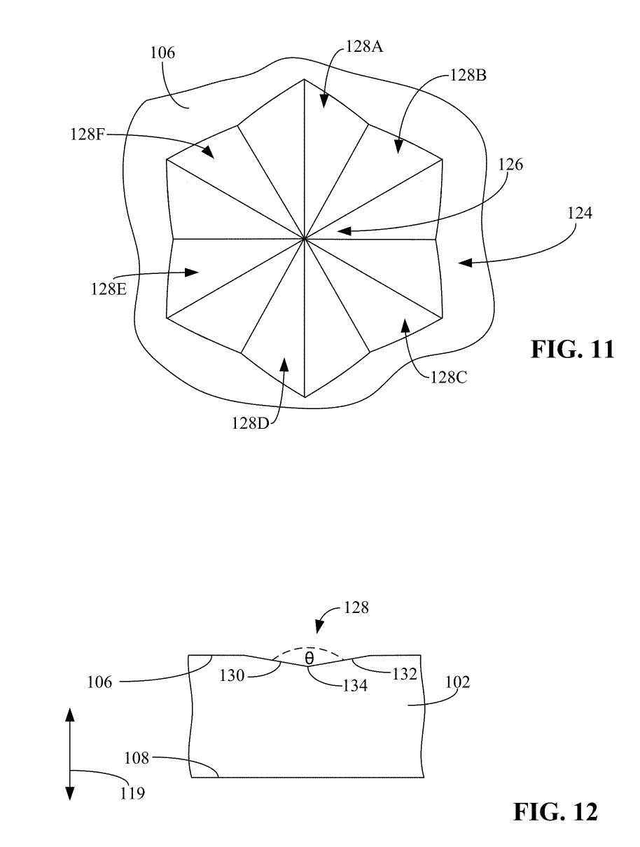

As described above, the included angle θ formed between the first side surface 130 and the second side surface 132 of a given member 134 may be any suitable angle, and may be set for extracting light from the light guide at a defined intensity profile and/or light ray angle distribution. FIGS. 7-12 schematically show other exemplary embodiments of the cluster-shaped light extracting element 124 in which the respective members thereof 128A, 128B, 128C, 128D, 128E, 128F have different included angles θ as compared with the embodiment shown in FIG. 4. In one example of the cluster-shaped light extracting element shown in FIGS. 7 and 8, the included angle θ formed between the first side surface 130 and the second side surface 132 is about 120°. Each of the members of the cluster-shaped light extracting element may have nominally the same included angle θ. In one example of the cluster-shaped light extracting element shown in FIGS. 9 and 10, the included angle θ formed between the first side surface 130 and the second side surface 132 is about 145°. Each of the members of the cluster-shaped light extracting element may have nominally the same included angle θ. In one example of the cluster-shaped light extracting element shown in FIGS. 11 and 12, the included angle θ formed between the first side surface 130 and the second side surface 132 is about 160°. Each of the members of the cluster-shaped light extracting element may have nominally the same included angle θ. As exemplified by the embodiments shown in FIGS. 7-12, increasing the included angle θ may widen the respective members (e.g., in a direction orthogonal to the direction in which ridge 134 of the member extends and extending normal to the major surface).

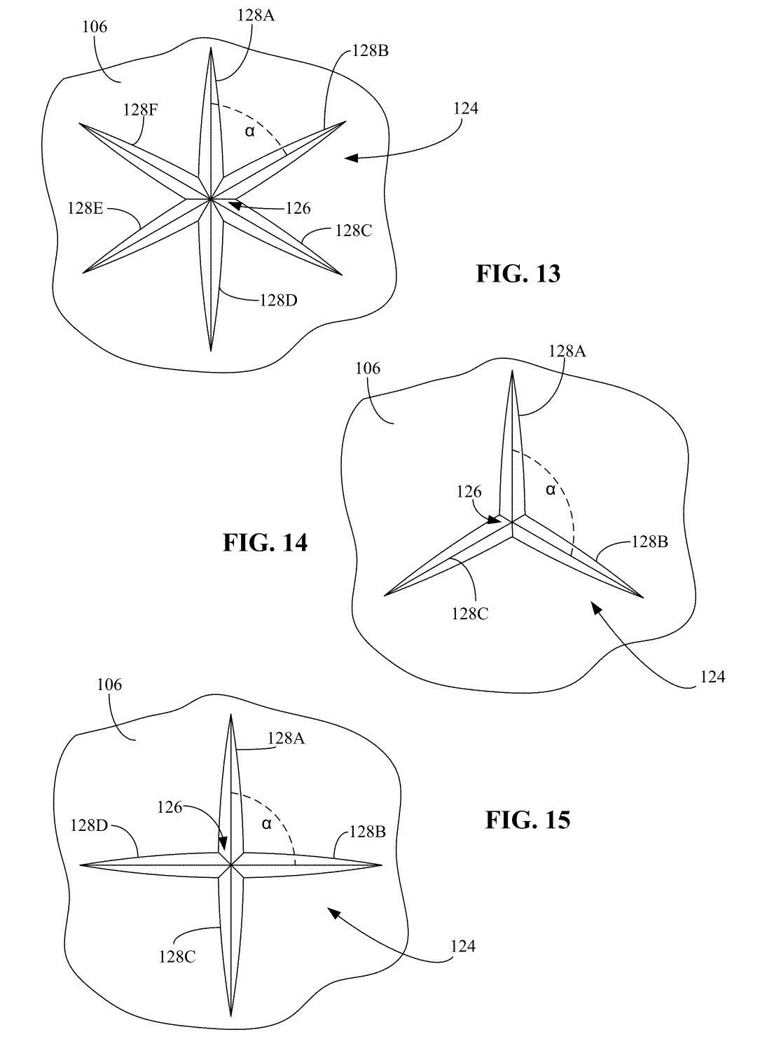

In the examples shown thus far in the figures, the cluster-shaped light extracting element 124 includes six members extending from the intersection portion 126 in a plane parallel to the major surface at which the element is formed. In other embodiments, the cluster-shaped light extracting element may include a larger or smaller total number of members 128. In an example, the cluster-shaped light extracting element may include three or more members (e.g., the total number of members may be three, five, seven, eight, or more). Furthermore, the angle α formed between two adjacent members 128 of the cluster-shaped light extracting element 124 may in some embodiments vary depending on the number of members of the element. For example, FIG. 13 shows an exemplary embodiment of the cluster-shaped light extracting element similar to that shown in FIG. 4, including six members 128A, 128B, 128C, 128D, 128E, 128F extending from the intersection portion 126. In this example, the angle α formed between two adjacent members is 60°. FIG. 14 shows another example of the cluster-shaped light extracting element that includes three members 128A, 128B, 128C extending from the intersection portion 126. In this example, the angle α formed between two adjacent members is 120°. FIG. 15 shows another example of the cluster-shaped light extracting element including four members 128A, 128B, 128C, 128D extending from the intersection portion 126. In this example, the angle α formed between two adjacent members is 90°.

Reference is made to FIGS. 5 and 6 for describing the side surfaces and the ridge of the respective members of the cluster-shaped light extracting elements shown in FIGS. 13-15. For example, in some embodiments, the respective ridges of the members of the exemplary cluster-shaped light extracting elements shown in FIGS. 13-15 may be arcuate in shape as viewed from a direction orthogonal to the thickness direction 119 and orthogonal to the direction in which the ridge 134 of the member extends (e.g., arcuate in a plane perpendicular to the major surface and parallel to the direction in which ridge 134 of the member extends), similar to that shown in FIG. 5. Furthermore, in some embodiments, the respective first and second surfaces of the members of the exemplary cluster-shaped light extracting elements shown in FIGS. 13-15 may intersect, and an included angle θ formed between the first side surface 130 and the second side surface 132 may be provided similar to that shown and described with respect to FIG. 6.

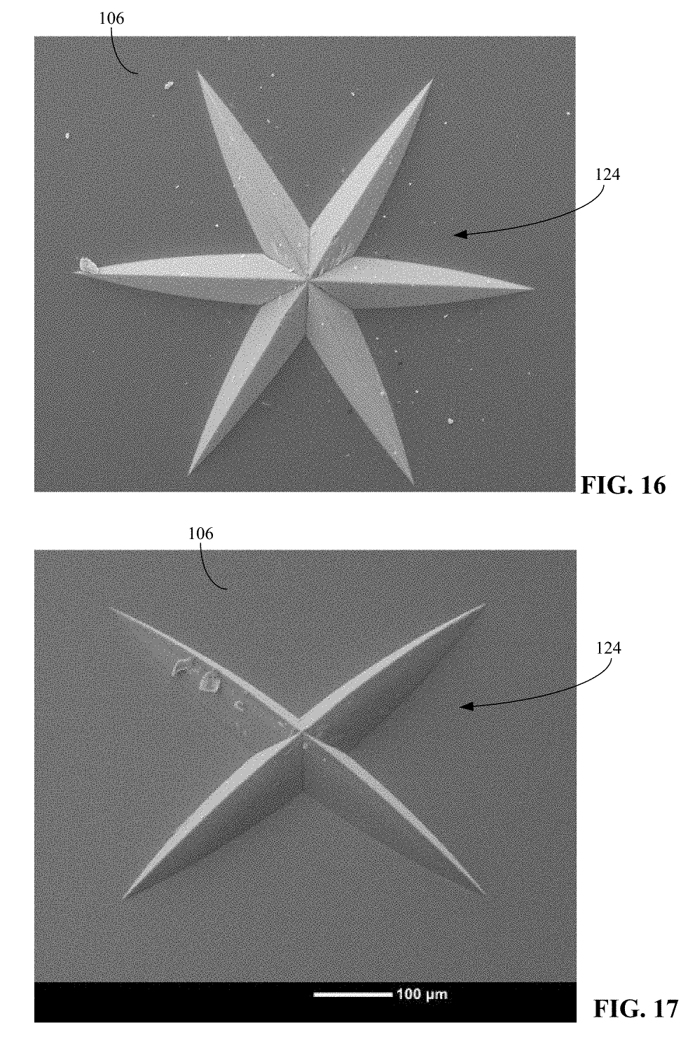

FIG. 16 shows an SEM image of an exemplary cluster-shaped light extracting element similar to that shown in FIGS. 4 and 13, but the cluster-shaped light extracting element of FIG. 16 is instead provided as a protrusion at the major surface. FIG. 17 shows an SEM image of an exemplary cluster-shaped light extracting element similar to that shown in FIG. 10, but the cluster-shaped light extracting element of FIG. 17 is instead provided as a protrusion at the major surface. As mentioned above, any of the embodiments of the cluster-shaped light extracting element shown and described herein may be provided as a protrusion or as a depression at the major surface.

In the exemplary embodiments of the cluster-shaped light extracting element discussed above, each of the members of the light extracting element may have nominally the same shape, size, and configuration. For example, the members of a given cluster-shaped light extracting element may be nominally the same with respect to length, included angle, angle of the first and/or second surface, ridge shape, surface roughness, depth, extension from the intersection portion, etc. Such embodiments of the cluster-shaped light extracting element may provide a nominally symmetric light output distribution even when light is input to the light guide in different directions (e.g., from different edge surfaces). In other embodiments, one or more of the members may differ from the other members with respect to one or more of length, included angle, angle of the first and/or second surface, ridge/surface shape, surface roughness, depth, extension from the intersection portion, etc. By providing asymmetry with respect to the members, the cluster-shaped optical element may provide additional control over light output distribution depending on the direction that the light is incident the cluster-shaped light extracting element.

In the exemplary embodiments described above, the members of the cluster-shaped light extracting element may be arranged such that the angle α formed between adjacent members 128 is the same for each set of adjacent members. For example, in FIGS. 4 and 13, the angle α formed between two adjacent members is 60° for each set of adjacent members. In other embodiments, the members of the cluster-shaped light extracting element may be arranged such that the angle α formed between adjacent members differs for at least one set of adjacent members as compared with the other sets of adjacent members. That is, the radial spacing of the respective members of the cluster-shaped light extracting element may vary in some embodiments. These different angles between the respective sets of adjacent members in the element may be any suitable angles.

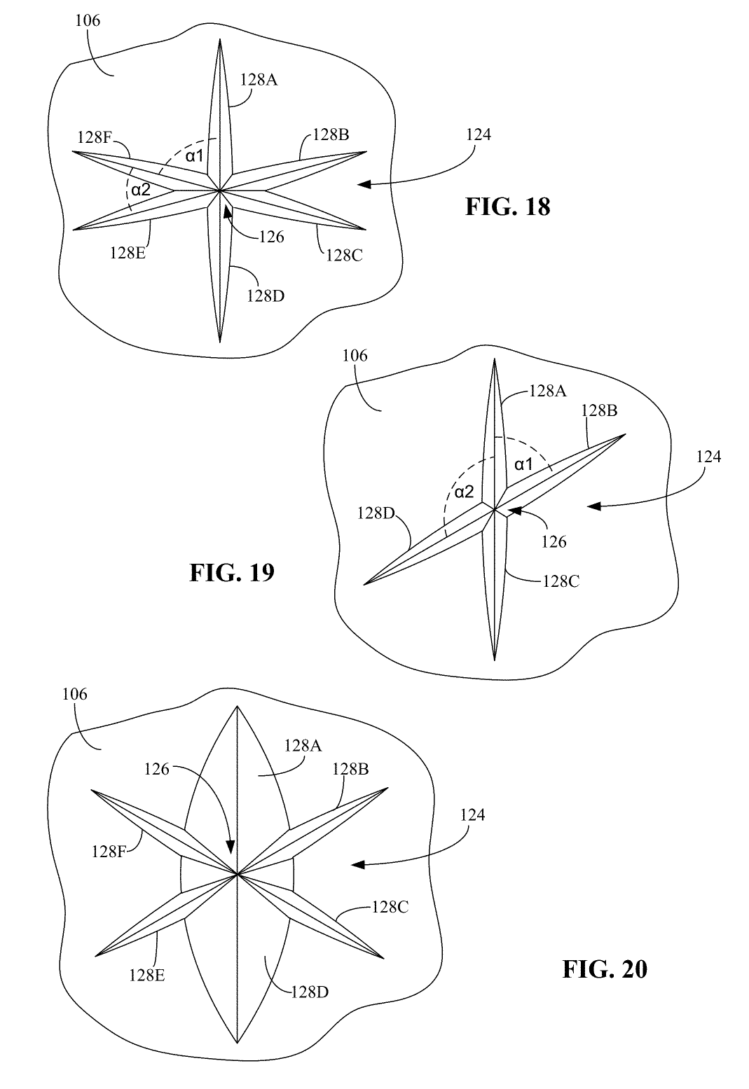

FIGS. 18 and 19 show exemplary embodiments in which the angle between respective sets of adjacent members varies among the sets of the cluster-shaped light extracting element. In FIG. 18, an exemplary embodiment of a cluster-shaped light extracting element is shown that includes six members, where the angle formed between member 128F and 128A, the angle formed between member 128A and 128B, the angle formed between member 128C and 128D, and the angle formed between member 128D and 128E are all nominally the same (i.e., α1). The angle formed between member 128B and 128C, and the angle formed between member 128E and 128F, are both nominally the same (i.e., α2). In the exemplary embodiment shown in FIG. 18, the value of α1 is larger than the value of α2. For example, α1 in the exemplary embodiment shown in FIG. 18 may be 50°, whereas the angle formed between another set of adjacent members in the element may be 30°.

In FIG. 19, an exemplary embodiment of a cluster-shaped light extracting element is shown that includes four members, where the angle formed between member 128A and 128B, and the angle formed between member 128C and 128D, are both nominally the same (i.e., α1). The angle formed between member 128B and 128C, and the angle formed between member 128D and 128A are both nominally the same (i.e., α2). In the exemplary embodiment shown in FIG. 18, the value of α1 is smaller than the value of α2. For example, α1 in the exemplary embodiment shown in FIG. 19 may be 70°, whereas the angle formed between another set of adjacent members in the element may be 110°.

In the embodiments shown in FIGS. 4-19, the included angle θ of the respective members for a given cluster-shaped light extracting element is nominally the same. In other embodiments, the included angle θ of one or more of the members may differ from the included angle of the other members. FIG. 20 shows an exemplary embodiment in which two of the six members have an included angle θ that is larger than the remaining four members. In the example, members 128A and 128D have an included angle similar to that shown in FIGS. 9 and 10. Members 128B, 128C, 128E, and 128F each have an included angle similar to that shown in FIGS. 4 and 6.

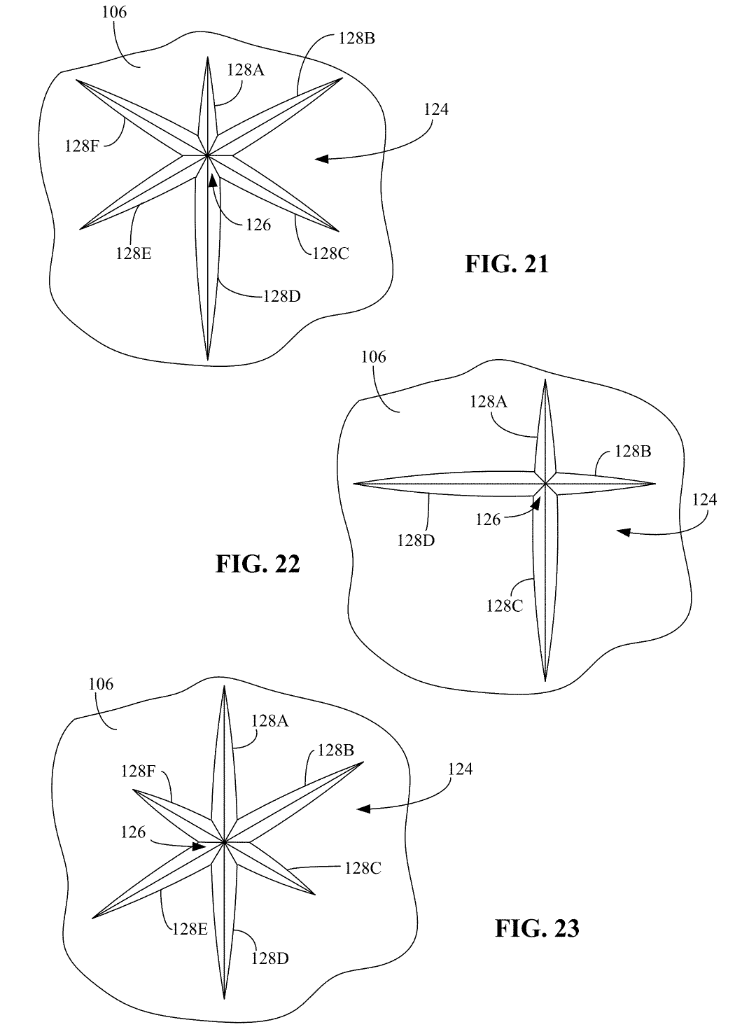

In the exemplary embodiments described above, the respective lengths of the members of the cluster-shaped light extracting element extending between the intersection portion 126 and the distal end 138 of the member are nominally the same. For example, in the embodiment of the element shown in FIG. 4, the members radially extend from the intersection portion and have nominally the same length extending between the intersection portion 126 and the distal end 138. In other embodiments, at least one of the members of the cluster-shaped light extracting element may have a different length extending between the intersection portion 126 and the distal end 138 as compared with the other members of the cluster-shaped light extracting element. FIGS. 21-23 show exemplary embodiments in which the respective lengths of the one or more of the members may differ. In FIG. 21, an exemplary embodiment of a cluster-shaped light extracting element is shown that includes six members, where the respective lengths of members 128B, 128C, 128E and 128F are nominally the same. The length of member 128A is less than that of 128B, 128C, 128E and 128F. The length of member 128D is greater than that of 128A, 128B, 128C, 128E and 128F. In FIG. 22, an exemplary embodiment of a cluster-shaped light extracting element is shown that includes four members, where the respective lengths of members 128C and 128D are nominally the same. The respective lengths of members 128A and 128B are nominally the same, but are shorter than 128C and 128D. In FIG. 23, an exemplary embodiment of a cluster-shaped light extracting element is shown that includes six members, where the respective lengths of members 128A, 128B, 128D and 128E are nominally the same. The respective lengths of members 128C and 128F are nominally the same, but are shorter than 128A, 128B, 128D and 128E.

Reference is made to FIGS. 5 and 6 for describing the side surfaces and the ridge of the respective members of the cluster-shaped light extracting elements shown in FIGS. 18-23. For example, in some embodiments, the respective ridges of the members of the exemplary cluster-shaped light extracting elements shown in FIGS. 18-23 may be arcuate in shape as viewed from a direction orthogonal to the thickness direction 119 and orthogonal to the direction in which the ridge 134 of the member extends (e.g., arcuate in a plane perpendicular to the major surface and parallel to the direction in which ridge 134 of the member extends), similar to that shown in FIG. 5. Furthermore, in some embodiments, the respective first and second surfaces of the members of the exemplary cluster-shaped light extracting elements shown in FIGS. 18-23 may intersect, and an included angle θ formed between the first side surface 130 and the second side surface 132 may be provided similar to that shown and described with respect to FIG. 6.

In the exemplary embodiments described above, and as exemplified by the SEM photographs shown in FIGS. 7 and 11, the respective depths/heights of the members (e.g., in the thickness direction 119) of a given cluster-shaped light extracting element may be nominally the same. In other embodiments, the depth/height of one or more of the members may be greater (or less than) than the other members in the cluster-shaped light extracting element. Exemplary reference is made to FIGS. 6 and 8 to describe one exemplary embodiment where different members of a given cluster-shaped optical element. As shown, in embodiments where members having different respective included angles are provided, the difference in angle may result in different members having different depths/heights (e.g., the member having the included angle shown in FIG. 6 may be deeper than the member having the included angle shown in FIG. 6). Of course, in some embodiments, the depth/height of a given member may not be dependent on the included angle of a member. As an example, one or more of the respective members may be provided at a different depth/height as compared with the other embodiments, even if all the members have nominally the same included angle. As another example, the respective depths/heights of the members of a given cluster-shaped light extracting element may be nominally the same, even if all the members have nominally the same included angle.

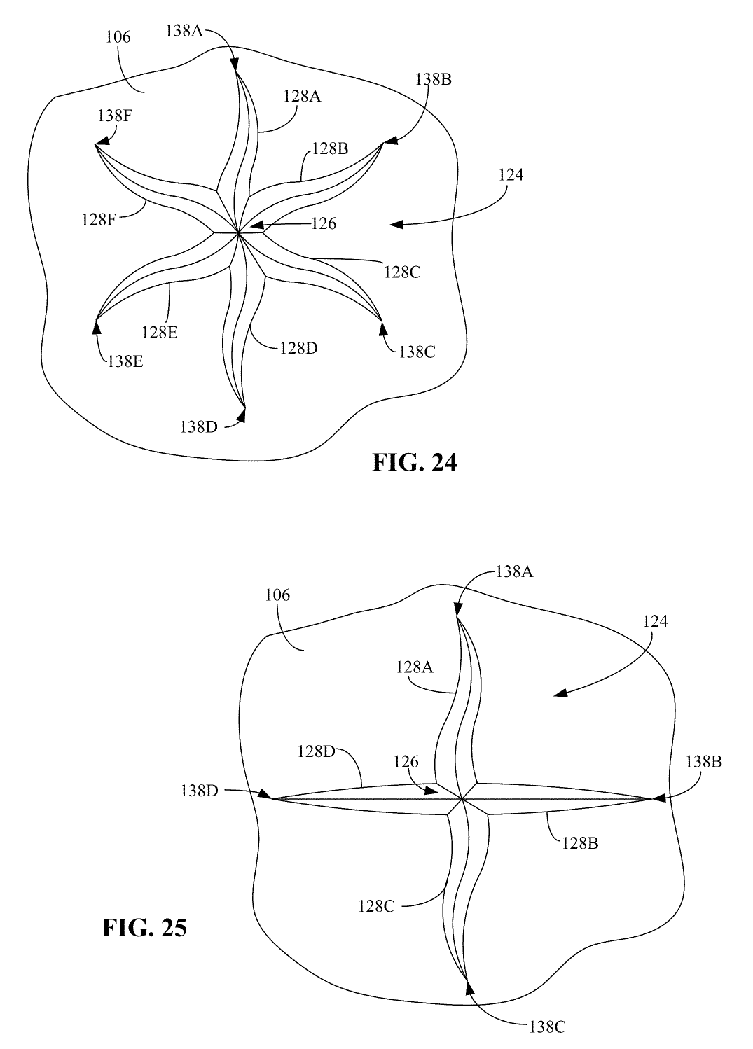

In the exemplary embodiments described above, the members of the cluster-shaped light extracting element 124 linearly extend from the intersection portion 126 in a plane parallel to the major surface at which the element is formed. With exemplary reference to FIG. 4, the ridge 134 of each member is linear as viewed in the plane of the major surface of the light guide. In other embodiments, one or more of the members (e.g., including its ridge and side surfaces) may be curved as viewed in the plane of the major surface of the light guide. FIGS. 24-27, reproduced below, schematically shows several exemplary embodiments of cluster-shaped light extracting elements including one or more members that extend non-linearly from the intersection portion 26.

In FIG. 24, an exemplary embodiment of a cluster-shaped light extracting element is shown that includes six members 128A, 128B, 128C, 128D, 128E, 128F, each of the members extending in a non-linear, winding path between the intersection portion 126 and the distal end 138A, 138B, 138C, 138D, 138E, 138F of the member as viewed from a direction orthogonal to the major surface at which the light extracting element 124 is formed (e.g., as viewed from a perspective parallel to the thickness direction 119). In some embodiments, the member may undulate as viewed from a direction orthogonal to the major surface (e.g., in the thickness direction). For example, in some embodiments, the ridge of the member is provided in a sinusoidal path such that it oscillates in a sinusoidal pattern as viewed from a direction orthogonal to the major surface. In an example, the ridge may oscillate in a sinusoidal pattern with a given period (frequency) and amplitude that is nominally constant and uniform from the intersection portion to the distal end of the light extracting element. FIG. 24 shows an exemplary embodiment in which each member includes about one cycle of the oscillating path/curve. In other embodiments, and depending on factors such as the period of oscillation and length of the member, the member may include less than or more than one cycle of the oscillating path/curve.

In other examples, the oscillation may vary in one or both of period (frequency) and amplitude between the intersection portion and the distal end of the light extracting element. For example, the oscillation may increase and/or decrease in one or both of period (frequency) and amplitude. In still another example, the ridge may oscillate in a sinusoidal pattern for a portion of the distance between the intersection portion and the distal end of the light extracting element, while one or more other portions between the intersection portion and the distal end of the light extracting element may be linear. Hence, the ridge may be partially sinusoidal and partially linear, pseudo-random, or any other suitable shape. As a result of the oscillation of the ridge 134, the first side surface 130 and the second side surface 132 are also non-planar surfaces, with their specific shape corresponding to the shape (e.g., oscillation) of the ridge. As shown in the example, the first side surface 130 and the second side surface 132 are provided as undulating surfaces (e.g., a wave shape).

In some embodiments, the members of the cluster-shaped light extracting element 124 all have the same non-linear, partially sinusoidal and partially linear, or pseudo-random configuration. In other embodiments, one or more of the members of the cluster-shaped light extracting element have different respective configurations. As an example, FIG. 25 shows an exemplary embodiment of a cluster-shaped light extracting element that includes four members 128A, 128B, 128C, 128D, in which members 128A and 128C extend in a non-linear, winding path as viewed from a direction orthogonal to the major surface at which the light extracting element is formed; and in which members 128B and 128D extend linearly as viewed from a direction orthogonal to the major surface at which the light extracting element is formed. In another example (not shown), each of the members may extend in a non-linear, winding path between the intersection portion 126 and the distal end of the member, with one or more of the members having a given period and/or amplitude that is different than the period and/or amplitude of the other members.

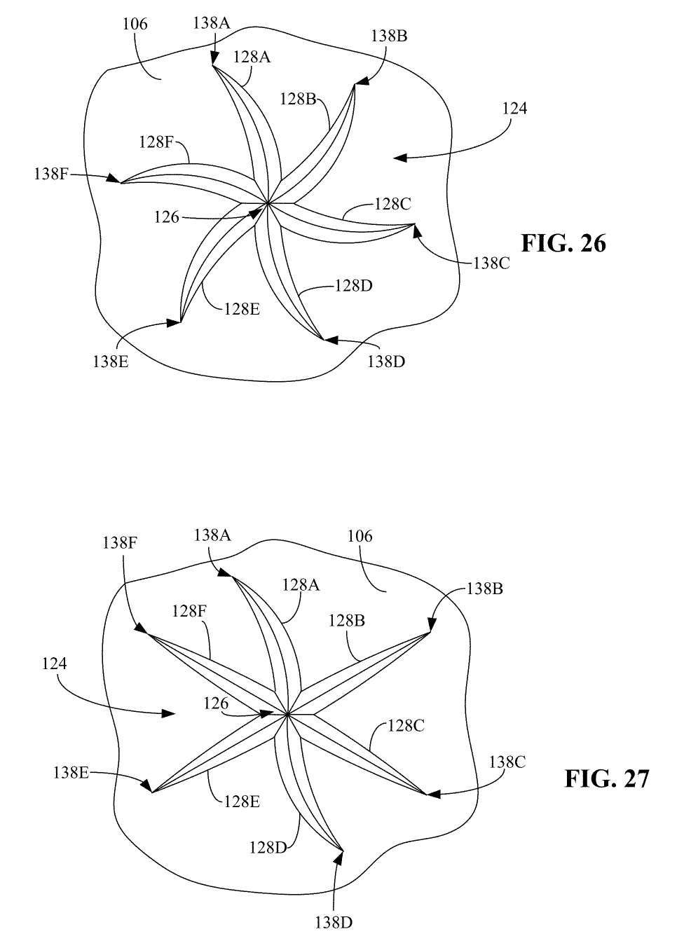

In FIG. 26, an exemplary embodiment of a cluster-shaped light extracting element is shown that includes six members 128A, 128B, 128C, 128D, 128E, 128F, each of the members extending non-linearly as viewed from a direction orthogonal to the major surface such that the member curves about a respective axis extending perpendicular to the major surface at which the micro-optical element is formed (e.g., about an axis parallel to the thickness direction 119). In the embodiment shown in FIG. 26, the radius of curvature of a given member is nominally constant. In other embodiments (not shown), the radius of curvature varies at at least one portion along a given member. Furthermore, in some embodiments, the radius of curvature may be the same among the members. In other embodiments, at least one member may have a radius of curvature that is different than the radius of curvature of the other members.

In some embodiments, such as that shown in FIG. 26, the members of the cluster-shaped light extracting element all have nominally the same non-linear configuration. In other embodiments, one or more of the members of the cluster-shaped light extracting element have different respective configurations. As an example, FIG. 27 shows an exemplary embodiment of a cluster-shaped light extracting element that includes six members 128A, 128B, 128C, 128D, 128E, 128F, in which members 128A and 128D extend non-linearly as viewed from a direction orthogonal to the major surface at which the light extracting element is formed such that they each curve about a respective axis extending perpendicular to the major surface at which the micro-optical element is formed (e.g., about an axis parallel to the thickness direction 119). Members 128B, 128C, 128E, and 128F each extend linearly as viewed from a direction orthogonal to the major surface at which the cluster-shaped light extracting element is formed.

Reference is made to FIGS. 5 and 6 for describing the side surfaces and the ridge of the respective members of the cluster-shaped light extracting elements shown in FIGS. 24-27. For example, in some embodiments, the respective ridges of the members of the exemplary cluster-shaped light extracting elements shown in FIGS. 24-27 may be arcuate in shape as viewed from a direction orthogonal to the thickness direction 119 and orthogonal to the direction in which the ridge 134 of the member extends (e.g., arcuate in a plane perpendicular to the major surface and parallel to the direction in which ridge 134 of the member extends), similar to that shown in FIG. 5. Furthermore, in some embodiments, the respective first and second surfaces of the members of the exemplary cluster-shaped light extracting elements shown in FIGS. 24-27 may intersect, and an included angle θ formed between the first side surface 130 and the second side surface 132 may be provided similar to that shown and described with respect to FIG. 6.

In the embodiments described above, the members of the cluster-shaped light extracting element each include a ridge 134. In other embodiments, one or more of the members may be configured such that a connecting surface (e.g., end surface) connects the first and second surfaces.

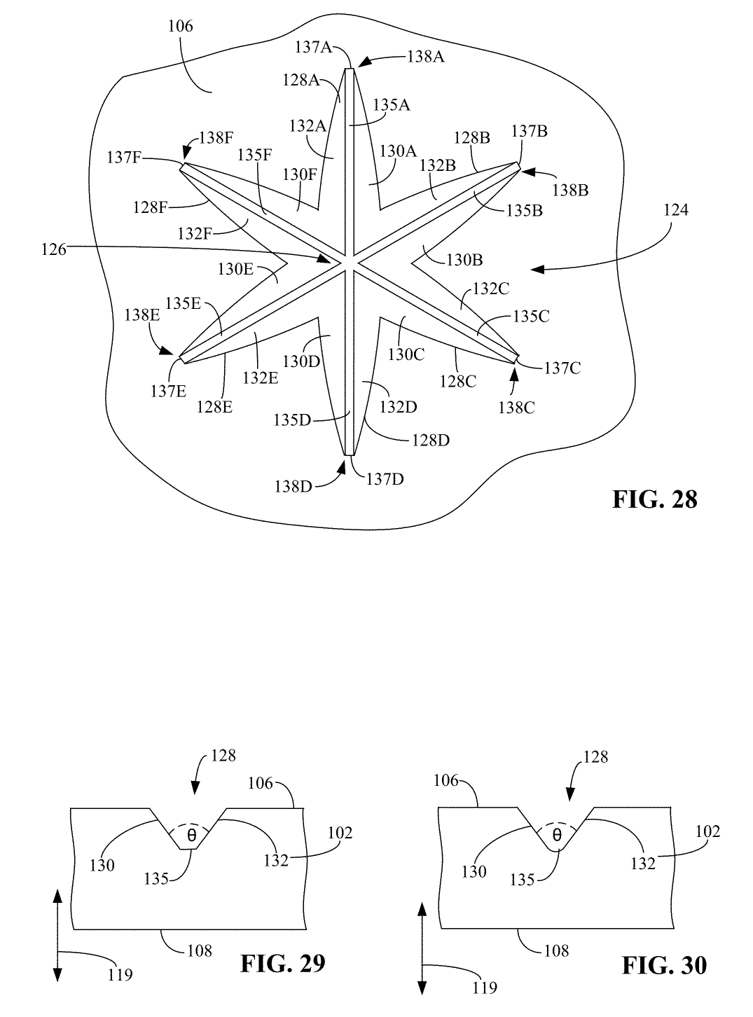

FIG. 28 shows an exemplary embodiment of a cluster-shaped light extracting element that includes six members 128A, 128B, 128C, 128D, 128E, 128F. The exemplary cluster-shaped light extracting element shown in FIG. 28 differs from the exemplary cluster-shaped light extracting element shown in FIG. 4 in that the first side surface and the second side surface of each member are joined by the connecting surface instead of by a ridge. Each member includes a respective first side surface 130A, 130B, 130C, 130D, 130E, 130F, a respective second side surface 132A, 132B, 132C, 132D, 132E, 132F, and a respective connecting surface 135A, 135B, 135C, 135D, 135E, 135F. Reference numeral 135 will be used to refer generally to the respective connecting surfaces of the members. Such shape including the side surfaces and connecting surface may be regarded as a “truncated” shape. Similar to the arrangement of the ridge, the connecting surface of a given member has a respective first end 137A, 137B, 137C, 137D, 137E, 137F that intersects the major surface at which the cluster-shaped light extracting element is formed, and the connecting surface extends to the intersection portion 126. The part of the connecting surface that intersects with one or more respective connecting surfaces of the other members at the intersection portion 126 may also be referred to as the second end of the ridge.

With reference to FIG. 29, in some embodiments, the connecting surface 135 is a planar surface as viewed from a direction orthogonal to the thickness direction 119 and parallel to the direction in which connecting surface of the member extends between the intersection portion 126 and the distal end 138 of the member. In other embodiments, and with additional reference to FIG. 30, the connecting surface 135 is arcuate as viewed from a direction orthogonal to the thickness direction of the light guide and parallel to the direction in which connecting surface of the member extends between the intersection portion 126 and the distal end 138 of the member.

The included angle θ (FIGS. 29 and 30) formed between the first side surface 130 and the second side surface 132 may be any suitable angle, and may be set for extracting light from the light guide 102 at a defined intensity profile and/or light ray angle distribution. As an example, the included angle θ may range from 30 degrees to 165 degrees. In some embodiments, the first side surface 130 and the second side surface 132 are symmetric relative to a plane extending parallel to the connecting surface 135 and extending normal to the major surface. In other embodiments, the first side surface 130 and the second side surface 132 are asymmetric relative to a plane extending parallel to the connecting surface 135 and extending normal to the major surface.

FIG. 28 shows an exemplary embodiment of a cluster-shaped light extracting element that is similar to the exemplary cluster-shaped light extracting element shown in FIG. 4, but differs in the respect that the first side surface and the second side surface of each member are joined by the connecting surface instead of by a ridge. It will be appreciated that any other exemplary embodiment of the cluster-shaped light extracting element described in the present disclosure may include a connecting surface in place of a ridge.

In the embodiments described above, and with exemplary reference to FIG. 5, the ridge (or surface) of the respective members of the cluster-shaped light extracting element the ridge 134 may be arcuate in shape as viewed from a direction orthogonal to the thickness direction 119 of the light guide and parallel to the direction in which the ridge or connecting surface extends. In other embodiments, one or more of the members may be configured such that the ridge or connecting surface is partially arcuate and partially linear as viewed from a direction orthogonal to the thickness direction of the light guide and parallel to the direction in which the ridge or connecting surface extends.

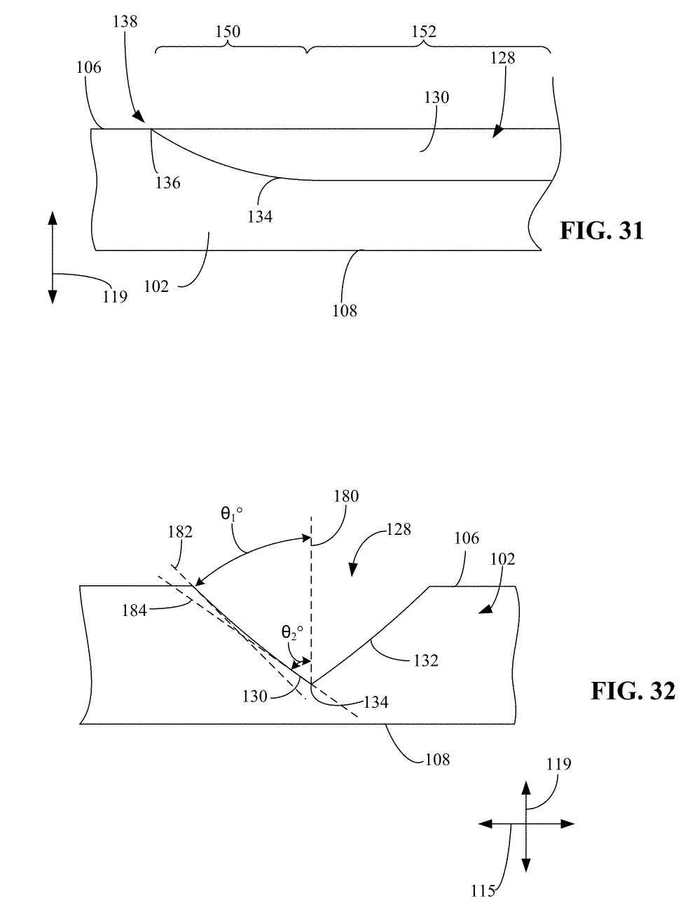

With exemplary reference to FIG. 31, a cross-sectional view is shown of one of the members of a cluster-shaped light extracting element as viewed from a direction orthogonal to the thickness direction 119 and orthogonal to the direction in which the ridge or connecting surface of the member extends. The ridge 134 or connecting surface 135 includes an arcuate portion 150 and a linear portion 152 as viewed from a direction orthogonal to the thickness direction of the light guide and orthogonal to the direction in which the ridge or connecting surface extends. As shown, the arcuate portion 150 is proximate the distal end 138 of the member and the linear portion 152 is proximate the intersection portion 126. Hence, in some embodiments, the ridge or connecting surface may include a non-uniform radius as viewed from a direction orthogonal to the thickness direction of the light guide and orthogonal to the direction in which the ridge or connecting surface extends. This shape/curvature of the ridge may also be referred to as a “dragged” shape/curvature. In still other embodiments (not shown), the ridge 134 or connecting surface 135 may be at least partially sinusoidal in shape as viewed from a direction orthogonal to the thickness direction of the light guide and orthogonal to the direction in which the ridge or connecting surface extends. It will be appreciated that any of the embodiments of the cluster-shaped light extracting element described in the present disclosure may include the dragged and/or sinusoidal shape/curvature of the ridge or connecting surface in place of a ridge.

In the examples described above, and with exemplary reference to FIGS. 6, 8, 10, 12, 29, and 30, the first side surface and the second side surface of a given member may be planar when viewed in a plane perpendicular to the major surface and perpendicular to the direction in which the ridge or connecting surface extends between the intersection portion and the distal end. In other embodiments, one or more of the members may be configured such that one or both of the first side surface 130 and the second side 132 surface include a curvature about a direction (e.g., an axis) extending in a plane parallel to the major surface of the light guide (or about a direction extending along a surface contour of the major surface of a non-planar light guide). In some embodiments, this direction about which the surface curves is parallel to the ridge or connecting surface (e.g., parallel to the direction in which the ridge or connecting surface extends between the intersection portion and the distal end). With exemplary reference to FIG. 32, the first side surface 130 and/or the second side surface 132 of one or more of the given members 128 may be curved when viewed in a plane perpendicular to the major surface and perpendicular to the ridge. The term “curvature,” when used herein to refer to the curvature of a surface of the light extracting element about a direction extending in a plane parallel to the major surface of the light guide (or about a direction extending along a surface contour of the major surface of a non-planar light guide), is defined as a change in angle of the surface of the light extracting element relative to the normal to the major surface along the surface of the light extracting element extending between the major surface and the ridge (or connecting surface) of the light extracting element. Curvature about a direction extending in a plane parallel to the major surface of the light guide (or about a direction extending along a surface contour of the major surface of a non-planar light guide) is contrasted with a curved shape of a light extracting element when viewed from a direction normal to the major surface of the light guide.

In the example shown in FIG. 32, each of the first side surface 130 and the second side surfaces 132 of the light extracting element 128 has a curvature about a direction extending in a plane parallel to the major surface of the light guide. A tangent 182 extending from the first side surface 130 at a point proximate the major surface at which the optical element is formed is arranged at an angle θ₁° relative to the normal 180 to the major surface. A tangent 184 extending from the first side surface 130 at a point proximate the ridge is θ₂° relative to the normal 180 to the major surface 106. The angle θ₂° is greater than the angle θ₁°. This change in angle evidences the curvature in the side surface of the element 124.

It will be appreciated that any of the embodiments of the cluster-shaped light extracting element described in the present disclosure may include curved side surface(s) curved when viewed in a plane perpendicular to the major surface and perpendicular to the ridge.

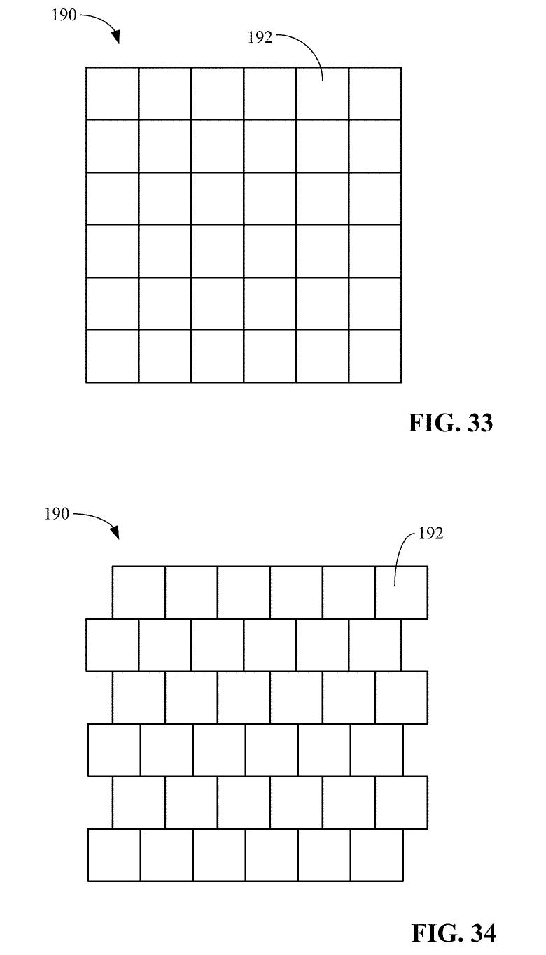

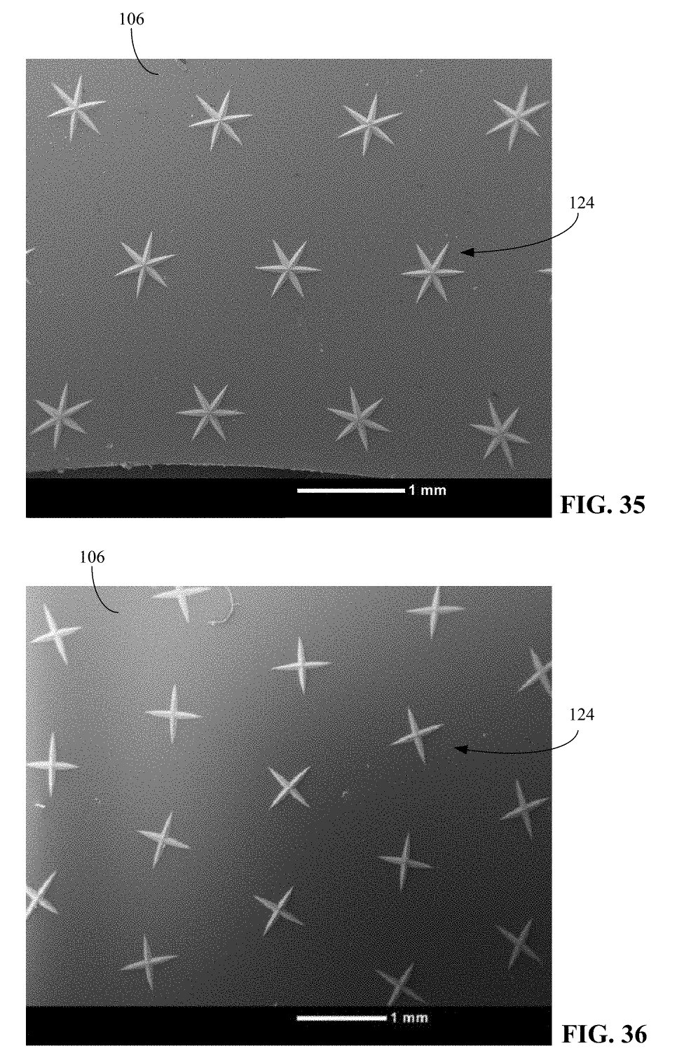

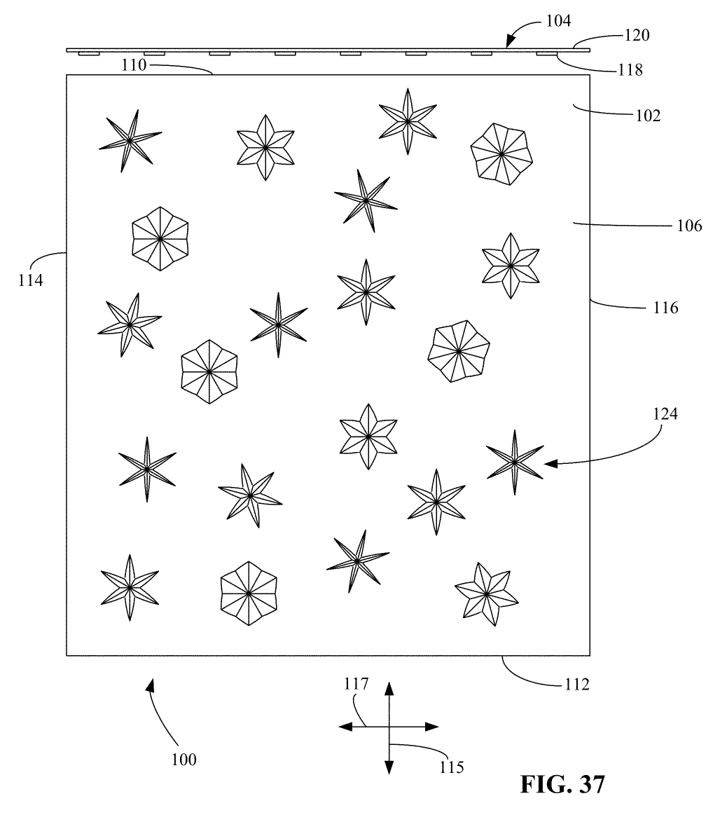

With continued reference to FIG. 1, the light guide 100 may include multiple instances of the cluster-shaped light extracting element 124 at one or both of its major surfaces 106, 108. In some embodiments, the cluster-shaped light extracting elements may be randomly arranged at the major surface of the light guide. In other embodiments, the cluster-shaped light extracting element may be arranged in an array or grid arrangement. FIG. 1 provides an exemplary embodiment of a randomized arrangement of micro-optical elements. FIGS. 33 and 34 show respective exemplary embodiments of grids 190, where a cluster-shaped light extracting element may be arranged in each box 192. FIGS. 35 and 36 show SEM images of parts of exemplary light guides including cluster-shaped light extracting elements. The elements shown in FIG. 35 are each provided as having nominally the same cluster-shaped light extracting element shape, including six members extending from the intersection portion. The elements shown in FIG. 36 are each provided as having nominally the same cluster-shaped light extracting element shape, including four members extending from the intersection portion. The elements shown in FIGS. 35 and 36 are arranged in a grid pattern similar to that shown in FIG. 34.

In some embodiments, the light extracting elements are all provided in nominally the same orientation at the major surface of the light guide. In other embodiments, and with reference to FIGS. 1, 35, and 36, at least a portion of the light extracting elements are rotated with respect to one another in the plane of the major surface. In some embodiments, the range within which the respective cluster-shaped may be rotated may depend, for example, on the number of members included in the element. In an example, where the cluster-shaped light extracting elements include six members with the angle α formed between two adjacent members of 60°, the rotational orientation of the elements may be within a range of 60°. In other embodiments, the respective light extracting elements may be provided in any suitable rotational arrangement.

The arrangement of the cluster-shaped light extracting elements at the one or more major surfaces of the light guide may allow for the light guide to be used as a “universal” type of light guide. Such a light guide including the cluster-shaped light extracting elements may be formed/cut into different sizes and/or be edge lit from different edges, and may maintain a nominally uniform surface appearance when illuminated. The cluster-shaped light extracting element may also enable the light guide to possess good visual aesthetics, such as minimal headlighting, even when the light guide is provided in different sizes and edge lit from one or more of its different edges. The light guide including the arrangement of cluster-shaped light extracting elements may be used in any suitable application, such as general lighting applications, display applications, automotive applications, agricultural applications, and the like.

In some embodiments, the cluster-shaped light extracting elements provided at the major surface of the light guide have the same or nominally the same shape, size, configuration, and/or orientation. In other embodiments, the cluster-shaped light extracting elements may vary in one or more of shape, size, configuration, and orientation. For example, the cluster-shaped light extracting elements provided at the major surface of the light guide may vary in one or more of shape, size, depth, height, slope angle, included angle, surface roughness, orientation, and/or index of refraction. This variation in light extracting elements may achieve a desired light output from the light guide.

FIG. 37 shows an exemplary lighting assembly including a light guide having several different shapes of the cluster-shaped light extracting elements at its major surface. In the example, four different embodiments of cluster-shaped light extracting elements are shown. Each of the embodiments of the cluster-shaped light extracting element includes six members, but the different embodiments vary with respect to the included angle θ of the side surfaces of the member. One embodiment of the cluster-shaped light extracting element is similar to the embodiment shown in FIG. 4, another embodiment of the cluster-shaped light extracting element is similar to the embodiment shown in FIG. 7, another embodiment of the cluster-shaped light extracting element is similar to the embodiment shown in FIG. 9, and another embodiment of the cluster-shaped light extracting element is one similar to the embodiment shown in FIG. 11. In some embodiments, the different embodiments of the light extracting elements may be nominally homogeneously mixed among one another throughout the major surface. In some embodiments, the different shaped light extracting elements may be provided in nominally the same amount. For example, with the embodiment in which four different embodiments of cluster-shaped light extracting elements are shown, the cluster-shaped light extracting elements may be provided such that the amount of each embodiment relative to the total number of light extracting elements is nominally the same (e.g., about 25% of each embodiment). In another other example, the different shaped light extracting elements may be provided in different respective amounts, with such amounts being adjusted to achieve a desired light output. As an example, the elements similar to the embodiment shown in FIG. 4 may constitute about 15%-25% of the total optical elements provided at the major surface of the light guide, the elements similar to the embodiment shown in FIG. 7 may constitute about 15%-25% of the total optical elements provided at the major surface of the light guide, the elements similar to the embodiment shown in FIG. 9 may constitute about 25%-35% of the total optical elements provided at the major surface of the light guide, and the elements similar to the embodiment shown in FIG. 11 may constitute about 25%-35% of the total optical elements provided at the major surface of the light guide.

In some embodiments, only cluster-shaped light extracting elements are provided at the major surface(s) of the light guide. In other embodiments (not shown), the cluster-shaped elements may be provided together with other non-cluster-shaped light extracting elements.

In the embodiments described above, the cluster-shaped optical elements (e.g., light extracting elements) are present at at least one of the major surfaces of a light guide (substrate). In other embodiments, cluster-shaped optical elements may be provided at the major surface of a different substrate, such as an optical film or cover element. In an example, the optical film including the cluster-shaped micro-optical element(s) may be in contact with a major surface of a light guide such that light from the light guide enters the optical film and is extracted via the cluster-shaped micro-optical element(s). The light guide (e.g., a slab light guide) including the optical film in contact with its major surface may also be collectively referred to as a light guide. The specific shape(s), configurations, and parameters of the cluster-shaped light extracting elements included at the major surface of the optical film may be the same as the shape(s), configurations, and parameters of the light extracting elements 124 described in connection with FIGS. 4-37. For the sake of brevity, the description of such shapes in the context of a cluster-shaped light extracting for the optical film element will not be repeated, but may equally apply in the context of the optical film.

In other embodiments, the cover element including the cluster-shaped micro-optical element(s) may be located adjacent a light guide such that the light extracted from the light guide may pass through the cover element, and the light may be redirected via the cluster-shaped micro-optical element(s) located at at least one of the major surfaces of the cover element.

Turning now to FIG. 38, another exemplary embodiment of a lighting assembly is shown at 200. The lighting assembly 200 is similar to the lighting assembly 100 shown in FIG. 1, but includes a cover element 260 located adjacent a major surface of the light guide 102. In the embodiment shown, light extracted from the light guide 102 (via light extracting elements) may be incident the cover element 260. The light extracting elements at the major surface of the light guide may include non-cluster-shaped light extracting elements, cluster-shaped light extracting elements, or a mixture of non-cluster-shaped light extracting elements and cluster-shaped light extracting elements.

The cover element 260 may be a solid article of manufacture (e.g., a substrate) made from, for example, polycarbonate, poly(methyl-methacrylate) (PMMA), glass, or other appropriate material; and may include a first major surface 262 and a second major surface 264 opposite the first major surface. With additional reference to FIG. 39, at least one edge surface extends between the major surfaces 262, 264 of the cover element (e.g., in the thickness direction 119). The total number of edge surfaces depends on the configuration of the cover element 260. The configuration of the cover element may correspond to the configuration of the light guide such that a major surface of the cover element conforms to the shape of the adjacent major surface of the light guide. For example, in the case where the light guide is rectangular, the cover element 260 may also be rectangular with four edge surfaces 266, 268, 270, 272. In the embodiment shown in FIG. 38, the major surfaces 262, 264 of the cover element are planar. In other embodiments, at least a portion of the major surfaces 262, 264 of the cover element is curved in one or more directions. In one example, the intersection of the edge surface 266 and one of the major surfaces 262, 264 defines a first axis, and at least a portion of the cover element curves about an axis parallel to the first axis. In another example, at least a portion of the cover element curves about an axis orthogonal to the first axis. The first major surface 262 of the cover element 260 may not be optically coupled with the first major surface 106 of the light guide 102 in order to avoid extracting light from the light guide 102 with the cover element 260. As shown, in some embodiments, the light guide 102 and the cover element 260 are separated by an air gap. In other embodiments, at least a portion of the second major surface 264 of the cover element and the first major surface 106 of the light guide and the cover element 260 may be in contact.

Light may pass through the major surfaces of the cover element and may be incident and redirected by the cluster-shaped optical element(s) present at at least one of the major surfaces of the cover element. The cover element may include light redirecting elements 224 configured to redirect light passed through the cover element. With specific reference to FIG. 39, the cover element 260 may include cluster-shaped light redirecting elements 124.

Similar to the light extracting elements described above, the light redirecting elements of the present disclosure are referred to herein as “cluster-shaped” because of the manner in which the members of the light extracting element are arranged and meet at the intersection portion of the element. The specific shape(s), configurations, and parameters of the cluster-shaped light redirecting elements 224 may be the same as the shape(s), configurations, and parameters of the light extracting elements 124 described in connection with FIGS. 4-37. For the sake of brevity, the description of such shapes in the context of a cluster-shaped light redirecting element will not be repeated, but may equally apply in the context of the cover element.

Light guides having light extracting elements, optical films having light extracting elements, and cover elements having light redirecting elements may be formed by a process such as injection molding. The light extracting/redirecting elements are typically defined in a shim or insert used for injection molding light guides by a process such as diamond machining, laser micromachining, photolithography, or another suitable process. Alternatively, any of the above-mentioned processes may be used to define the light extracting/redirecting elements in a master that is used to make the shim or insert. In other embodiments, light guides without light extracting/redirecting elements may be formed by a process such as injection molding or extruding, and the light extracting elements are subsequently formed on one or both of the major surfaces by a process such as stamping, embossing, or another suitable process.

One exemplary method of producing the above-described cluster-shaped light extracting elements and the above-described cluster-shaped light redirecting elements is by use of a patterning tool. The patterning tool is typically embodied as a solid article made from, for example, metal, acrylic, polycarbonate, PMMA, or other appropriate material. As an example, the patterning tool may be embodied as a linear cutting tool having a first machining edge configured to cut a surface that defines first side surface of the light extracting/redirecting element, and a second machining edge configured to cut a surface that defines the second surface of the light extracting/redirecting element. In some embodiments of the linear cutting tool, an intersection of the first machining edge and the second machining edge at an end of the machining element is configured to define the ridge of the light extracting/redirecting element. In other embodiments of the linear cutting tool, a third machining edge is configured to cut a surface that defines the connecting surface of the light extracting/redirecting element. The patterning tool may couple to an apparatus (e.g., a CNC lathe) for conducting the machining of a substrate, such as the light guide, cover element, shim/insert, or master.

In this disclosure, the phrase “one of” followed by a list is intended to mean the elements of the list in the alterative. For example, “one of A, B and C” means A or B or C. The phrase “at least one of” followed by a list is intended to mean one or more of the elements of the list in the alterative. For example, “at least one of A, B and C” means A or B or C or (A and B) or (A and C) or (B and C) or (A and B and C).

What is claimed is:

1. A light guide, comprising:
a first major surface;
a second major surface opposed the first major surface;
a light input edge extending between the first major surface and the second major surface, the first major surface and the second major surface configured to propagate light input to the light guide through the light input edge therebetween by total internal reflection; and
light extracting elements at at least one of the major surfaces, at least one of the light extracting elements embodied as a cluster-shaped light extracting element comprising:
an intersection portion; and
at least three members extending from the intersection portion, each member including a first side surface and a second side surface that come together to form a ridge or that are joined by a connecting surface, the ridge or connecting surface comprising a first end that intersects the major surface at which the light extracting element is formed and extending to the intersection portion where the ridge or connecting surface intersects with one or more ridges or connecting surfaces of the other respective members.

2. The light guide of claim 1, wherein the members extend radially from the intersection portion.

3. The light guide of claim 1, wherein each member extends linearly from the intersection portion.

4. The light guide of claim 1, wherein at least one of the members extends non-linearly from the intersection portion.

5. The light guide of claim 4, wherein the at least one of the members curves about an axis extending perpendicular to the major surface at which the light extracting element is formed.

6. The light guide of claim 4, wherein the at least one of the members extends from the intersecting portion in a sinusoidal pattern.

7. The light guide of claim 1, wherein the at least one of the light extracting elements comprises at least six members extending from the intersecting portion.

8. The light guide of claim 1, the light extracting elements comprising multiple instances of the cluster-shaped light extracting element.

9. The light guide of claim 8, wherein at least a portion of the cluster-shaped light extracting elements have different respective shapes.

10. The light guide of claim 8, wherein at least a portion of the cluster-shaped light extracting elements have different respective rotational orientations.

11. A lighting assembly, comprising:
the light guide of claim 1; and
a light source adjacent the light input edge.

12. An optical element formed at a major surface of a substrate, comprising:
an intersection portion; and
at least three members extending from the intersection portion, each member including a first side surface and a second side surface that come together to form a ridge or that are joined by a connecting surface, the ridge or connecting surface comprising a first end that intersects the major surface at which the optical element is formed and extending to the intersection portion where the ridge or connecting surface intersects with one or more ridges or connecting surfaces of the other respective members.

13. The optical element of claim 12, wherein the members extend radially from the intersection portion.

14. The optical element of claim 12, wherein each member extends linearly from the intersection portion.

15. The optical element of claim 12, wherein at least one of the members extends non-linearly from the intersection portion.

16. The optical element of claim 15, wherein the at least one of the members curves about an axis extending perpendicular to the major surface at which the optical element is formed.

17. The optical element of claim 12, wherein at least one of the portion of the optical elements comprise at least six members extending from the intersecting portion.

18. The optical element of claim 12, wherein the substrate is a cover element, comprising:
a first major surface; and
a second major surface opposed the first major surface.

19. The optical element of claim 12, wherein the substrate is an optical film.

20. A light guide, comprising:
a first major surface;
a second major surface opposed the first major surface;
a light input edge extending between the first major surface and the second major surface, the first major surface and the second major surface configured to propagate light input to the light guide through the light input edge therebetween by total internal reflection; and
cluster-shaped light extracting means at at least one of the major surfaces for extracting light from the light guide through one or both of the first major surface and the second major surface.
